(19) United States
(12) Patent Application Publication
(10) Pub. No.: US 2001/0047076 A1
(43) Pub. Date: Nov. 29, 2001

(54) Process to obtain polyglycolyl urea from aromatic diglycinates for electric conductor insulation

(76) Inventors: Chio Arjona Alejandro Rafael, Jurica (MX); Diaz Gonzalez Carlos, P.de Churubusco (MX)

Correspondence Address: Law Office of Carmen Pili Curtis, 1031 Harrison Ave., Redwood City, CA, 94062, US

(21) Appl. No.: 09/750,483

(22) Filed: Dec. 28, 2000

(30) Foreign Application Priority Data
Apr. 16, 2000 (MX) 004019

(51) Int. Cl. C08F 6/12; C08F 6/10

(52) U.S. Cl. 528/501; 528/491; 528/495; 528/503

(57) ABSTRACT

A process for obtaining polyglycolyl urea from aromatic diglycinate, to insulate electric conductors without forming HCN polluting residues, characterized because a mixture of methylene bromopropionate and methylenedianiline in aliphatic solvent reacts in presence of a catalizer; the solvent is separated through distillation, filtration of the mother waters and purification through washing with water and addition to the resulting product of cresylic acid and methylene dilisocyanate under stirring, up to a temperature, of 60° C., and addition of a triethylenediamino catalizer, heating at a temperature of up to 185° C. and it is then distilled at a temperature of up to 200° C., obtaining a polyglycolyl urea hydantoin resin.

### BACKGROUND OF THE INVENTION

Several processes are known to obtain polyhydantoin polymers, that is, polymers containing hydantoin rings.

Among the known processes, we can mention the ones involving the reaction, through heating, of glycine derivatives and polyisocyanate or polythioisocyanates, at temperatures ranging from 80° C. to 500° C., in presence of a solvent. In U.S Pat. No. 3,397,253, a process is described to obtain polybydantoin polymers through heating glycine derivatives and polyisocyanates or polythioisocyanats at temperatures ranging from 80° C. to 500° C., being said compounds preferably N,N′-bis-carhetoxy methyl-4,4′diisocyanate-diphenylmethane in a cresol solvent. Another type of known processes consists in condensing aril-polyamines with sodium or potassium cyanides and oxo compounds, for example, formaldehyde, ketone, etc. through the addition of acids; the nitrites obtained are saponified to form carboxylic acids or esters with hydrochloric acid in alcohol.

Other processes consist in modifying already prepared glycine derivatives, for example, through free acid sterification or ester aminolysis.

In this type of processes, the polymerization reaction is usually in addition to the condensation of the two reagents, occurring a ring closure reaction to form a hydantoin ring according to the following scheme:

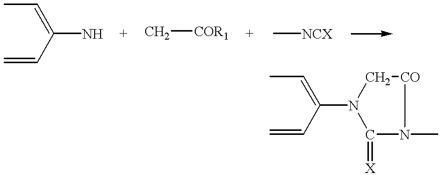

U.S. Pat. No. 5,006,641 teaches how to obtain polyhydantoins through a process involving the initial reaction of bis-glycine esters with diisocyanates in a liquid medium to form polyurea and then, through reaction, in a second stage, with a monoglyeine ester equivalent to the residual quantity of isocyanate terminal groups and finally polyhydantoin is obtained through cycle condensation.

In U.S. Pat. No. 5,041,518, a process is described to obtain polyhydantoins useful in coating materials, films, adhesives and molding through the reaction of polyfunctional carboxylic alfa-amino acids with organic poly(thio)cyanates and the addition of carboxylic acid compounds in presence of condensed aromatic hydrocarbon at temperatures ranging from 0° C. to 50° C.

The polymer compounds of bydantoin rings have several known applications according to their polymerization grade. When they are overheated at high temperatures, they turn into non melting high hardness products; it is also possible to obtain flexible coatings when polymerization is stopped before its final state and thus abrasion resistance and conventional resistance to several types of solvents can be obtained. Together with other shellac or mica products, materials in solutions as insulating elements for the electrical industry, especially electric coil wires, can be obtained.

The applicant has developed a process to obtain polyglycolyl urea from aromatic diglycinates, the main characteristic of which is that it does not form high risk polluting residual by-products such as ICN emission, obtaining a product that meets the main properties of such commercially available resins such as thermal, mechanic and chemical properties and even improving certain characteristics such as freon resistance of polyesterimide-type enameled products.

The process object of the present invention is also characterized because it reduces the number of unitary operations conducted, lowering thus the cost of the product.

### DESCRIPTION OF THE INVENTION

Hereinafter the invention will he described according to the process stages to obtain the polyglycolyl urea as well as its use, main object of the application, in the manufacturing of H-class magnet-wire with improved properties.

The process to obtain polyglycolyl urea PGU is divided in two main stages: A and B.

Stage A includes the following steps:

1) mixing the reaction solvents, bromided ester, diamine and catalyst;

2) Reacting the mixture to produce diglycinate in solution;

3) Purifying the diglycinate obtained through filtration, washing and drying;

Stage B includes the following steps:

4) loading aromatic isocyanate, diglycinate, solvents and catalyst in the polymerization, reactor,

5) obtaining polyglycolyl urea resin;

6) adding polyester-type electro-insulating varnishes;

7) manufacturing H-class magnet-wire with improved properties.

The chemical structure of the methyldimethyldiglycinate required to obtain the identical commercial polyhydantoin resin (PH-b from Bayer A. G.) is as follows:

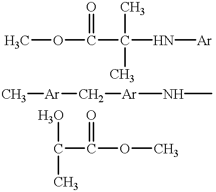

where Ar represents aromatic rings.

In order to develop a digiycinate countertype through an easier path without deriving dangerous, polluting by-products such as EICN and without presenting problems related to freon resistance when added with varnishes, as is the case with polyhydantoin resin, the applicant has identified two paths to obtain polyglycolyl urea:

Path 1: reductive amination

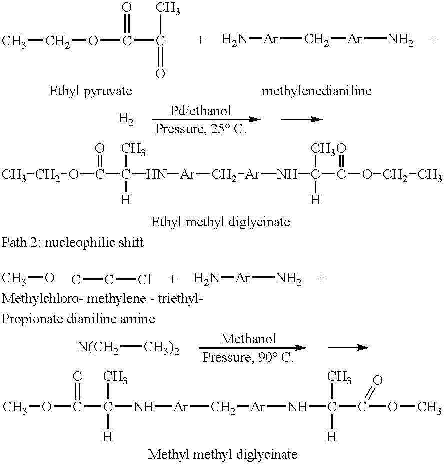

The nucleophilic shift process produces a diglycinate with better characteristics because it defines both methyl methyl diglycinate isomers.

Hereinafter Stage 2 is described, in which the halogen “chlorine” is substituted by “bromine” from the methyl propionate that gives better results in the removal of residual by-products.

### STAGE A

Obtainment of methyl diglycinate from methylenedianiline

a) in a glass or stainless steel matrass,, provided with stirring means, reflux column, heating and cooling systems, the following materials are added: methylenedianihine, methanol and methyl bromopropionate.

b) Under stirring, the solution is heated at methanol reflux temperature (58-63° C.); once this temperature is reached, triethylamine addition starts, at a rate of 0.178 l/hr per Kg of product during a 3-5 hour period.

c) The reaction is maintained under reflux during 19 hours.

d) Start methanol distillation at atmospheric pressure till 40% of its initial volume is recovered, the distilled methanol contains methyl acrylate obtained as side by-product induced by the base.

e) Cooling at 20° C. under stirring (products begin to crystalliz at 50° C. with a slight viscosity increase), then add the drinking water volume adequate to dissolve the bromine salt obtained. Continue stirring during 0.5 hour to homogenize the suspension formed.

f) Filter the suspension, letting it drain thoroughly in order to assure the removal of polar impurities with help from residual methanol; said impurities are identified in the mother waters as an oily residue that does not contain appreciable quantities of methyl diglycinate.

g) Wash or repulp the product with water; three washing or repulping steps are recommended to remove raw material or by-product residues. After each washing step, filter and drain.

h) Finally, dry the product with hot air at a temperature of 40° C. and in an obscure setting till a constant weight is obtained. Once dry, the product is kept in black bags and in a cool and dry place.

The product is a mixture of stercoisomers with a melting point of 95 to 116° C. (Fisher method).

Then the mother waters from step f), a mixture of reaction residues and by-products such as hydrated bromotrietylamine salts, are neutralized with sodium hydroxide and submitted to a secondary distillation to obtain sodium bromide in solution and 90% triethylamine.

### STAGE B

1 i) PGU synthesis is conducted in a stainless steel reactor provided with stirring, thermal oil heating, condenser and cooling system

Cresylic acid and methyl methyl diglycinate are added to the reactor at room temperature, and the suspension is stirred till the solution of the product is complete.

j) Then methylene diisocyanate is added, under constant stirring and preventing the temperature from rising above 60° C., because this stage of the reaction is exothermic. Said conditions are maintained during 3 hours and then viscosity is determined in a No. 4 Ford Cup on a polymer sample, when the viscosity is within a range from 44 to 47 seconds at a temperature of 25° C.

k) Then a triethylenediamino or 1,4-diazobicyclo (2,2,2) octane (DABCO) catalizer is added, and the operation conditions are maintained during 1.5 hours. Once this period has elapsed, temperature is raised to 180-185° C. in about 6 hours. Once this temperature is reached, it is maintained till the specified quantity of distillate is obtained, during a period of about 5 to 6 hours and temperature can be increased up to 200° C., if necessary.

Once the theoretical distillate is recovered, heating is stopped and the resin is cooled at 70° C. to unload the corresponding containers, and a polyglycolyl urea hydantoin resin of the following formula is obtained:

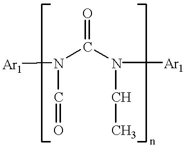

where Ar₁ is a substituted aromatic compound or a substituted diphenylalkyl, and 2<n<500, % solids 28.97

Viscosity (Cp)=4,800 at 15% solids.

In the following example the polyglycolyl urea (PGU) countertype resin is compared to a conventional resin PH-10 in a varnish.

Each resin is adjusted to a 1600 eps viscosity with cresol/xylol and catalizer to be used as enameling varnishes. First, PH-10 was coated on conductor gauge 14 AWG to determine the work parameter to compare; a flexibility failure was observed at 6m/min. The results are presented in a parameter from 8 to 16 vel. (m/min).

PH-10 BASED VARNISH

| Vel (m/min) | 6 | 10 | 14 | 16 |
|---|---|---|---|---|
| Adh and Flex | failure | good | good | good |
| Thermoplastic F. | 271° | 295° | 316° | 275° |
| Voltage (Kv) | 9.0 | 9.19 | 7.61 | 5.69 |
| Dissipation factor | 2.9 | 2.90 | 18.1 | 56.9 |

PGU-BASED VARNISH

| Vel (m/min) | 8 | 10 | 12 | 14 | 16 |
|---|---|---|---|---|---|
| Adh and Flex | good | good | good | good | 97% |
| Thermal shock | good | good | good | good | 93% |
| Thermoplastic F. | 340° | 310° | 284° | 249° | 231° |
| Voltage (Kv) | 7.43 | 7.80 | 7.34 | 8.44 | 7.04 |
| Dissipation Factor | 7.68 | 10.2 | 16.9 | 34.3 | 67.6 |

1. A process for obtaining polyglycolyl urea from aromatic diglycinates to insulate electric conductors, without forming HCN polluting residues, characterize because it consists of the following steps: in a reactor, under stirring and reflux conditions, reacting a mixture of methyl bromopropionate and methylenedianiline in a C₁-C₄ aliphatic solvent, at atmospheric pressure, up to solvent reflux temperature; adding a catalizer, preferably of triethylamine, at a rate of 0.178 l/ hour per Kg of product during a reaction time of 3 to 4 hours and reflux till 19 hours; solvent separation through atmospheric distillation; crystallization at 50° C.; mother waters filtration and purification through washing with water and drying of the methyl diglycinate obtained; a load of methyl methyl diglycinate is prepared in a reactor and cresylic acid is added, at room temperature, under stirring, till solution is complete; methylene diisocyanate is added, under stirring, up to a temperature of 60° C., during 2 to 4 hours till a product viscosity of 44 to 47 seconds at 25° C. is reached; addition of triethylenediamino or 1i4 diazobicyclo (2,2,2) octane; temperature increase up to 180° C. during a 6-hour period; then distillation up to a temperature of 200° C.; cooling at 70° C. and a polyglycolyl urea hydantoin resin of the following formula is obtained: 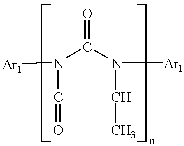
where Ar₁ is a substituted aromatic compound or a substituted diphenylalkyl and 2<n<500 with a viscosity (Cp)=4,800 at 15% solids.

2. The process for obtaining polyglycolyl urea according to claim 1, characterized because the C₁-C₄ solvent is preferably methanol.

3. The process according to claim 1, characterized because the reflux temperature of the C₁-C₄ aliphatic solvent is 58-63° C.

4. The process according to claim 1, characterized because the methyl methyl diglycinate obtained is dried with hot air at 40° C. and in an obscure setting and corresponds to a stereoisomer mixture with a melting point of 95-116° C., of the following general formula:
Ar₁[NH—CH(CH₃)—COOCH₃]₂

5. The process for obtaining polyglycolyl urea according to claim 1, characterized because the residues of the mother waters are by-products of the reaction of triethylamine bromohydrate salts which are neutralized with sodium hydroxide and separated through secondary distillation obtaining sodium bromide in solution and 90% triethylamine.
